(19) United States
(12) Patent Application Publication
(10) Pub. No.: US 2023/0138811 A1
(43) Pub. Date: May 4, 2023

(54) SIMULATING OPERATION OF THE PREMISES SECURITY SYSTEM

(71) Applicant: The ADT Security Corporation, Boca Raton, FL (US)

(72) Inventor: MARK REIMER, Denver, CO (US)

(21) Appl. No.: 17/977,244

(22) Filed: Oct. 31, 2022

Related U.S. Application Data
(60) Provisional application No. 63/273,599, filed on Oct. 29, 2021.

(51) Int. Cl. G06F 16/735; G06Q 30/00; G06F 9/451

(52) U.S. Cl. CPC G06F 16/735; G06Q 30/016; G06F 9/453

(57) ABSTRACT

Methods, systems, and devices are disclosed. In at least one embodiment, a server is configured to communicate with a premises device of a premises security system. The server includes processing circuitry configured to receive, from the premises device, a set of user analytics associated with a user, and a troubleshooting request. The processing circuitry is configured to instantiate a virtual machine instance, the virtual machine instance being configured to simulate operation of the premises device based on the set of user analytics. The processing circuitry is configured to generate, using the virtual machine instance, a digital video file simulating a plurality of actions associated with the troubleshooting request; and transmit the digital video file to a security system platform.

### CROSS-REFERENCE TO RELATED PATENT APPLICATION

This application is related to and claims priority to U.S. Provisional Patent Application Ser. No. 63/273,599, filed Oct. 29, 2021, entitled USER IMPERSONATION IN A SECURITY SYSTEM, the entirety of which is incorporated herein by reference.

### TECHNICAL FIELD

The present invention relates to premises security systems and/or security systems, and in particular, to diagnostics, troubleshooting, and technical support for the security system and/or premises security system.

### BACKGROUND

Modern smart home security systems are capable of provisioning and managing multiple low-power wireless networks (including but not limited to Zigbee, Thread, Z-Wave, DECT ULE, WiFi, and/or Bluetooth Low Energy) to control and/or communicate with home automation devices, such as lights, locks, and thermostats. Many of these systems also maintain and manage a separate security wireless network for intrusion detection and life safety sensors and detectors. In addition, many of these systems are built with redundancies in place to continue functioning in the event of a power failure or a connectivity failure. Such systems are becoming increasingly advanced home security and internet-of-things, IoT, gateways with edge compute capabilities running on modern operating systems.

However, as the complexity of these security systems increases, customers may be unaware of how to troubleshoot certain errors in the security systems. For example, a customer may not understand and/or realize that one configuration setting is not enabled for a premises device, which is why the premises device is not able to connect to the security system. In such situations, the customer may call a customer service center for the security system to troubleshoot the problem, but this interaction is often limited to the customer service representative talking the customer through various predefined steps.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example system comprising a premises security system and/or a security system platform according to principles disclosed herein;

FIG. 2 is a block diagram of some devices in the system according to some embodiments of the present disclosure;

FIG. 3 is a flowchart of an example process for improving security and privacy for troubleshooting technical issues with a security system;

FIG. 4 is a flowchart of an example process for a server for performing autonomous support according to some embodiments of the present invention;

FIG. 5 is a flowchart of another example process for a server for performing autonomous support according to some embodiments of the present invention; and

FIG. 6 is a signal diagram corresponding to the steps of FIG. 3.

### DETAILED DESCRIPTION

Before describing in detail exemplary embodiments, it is noted that the embodiments may reside in combinations of apparatus components and processing steps related to simulating operation of a premises security system. Accordingly, components have been represented where appropriate by conventional symbols in the drawings, focusing only those specific details that facilitate understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes,” “including,” “has,” and “having,” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication. In some embodiments described herein, the term “coupled,” “connected,” and the like, may be used herein to indicate a connection, although not necessarily directly, and may include wired and/or wireless connections. The terminology used herein is for the purpose of describing particular embodiments only and is not intended to be limiting of the concepts described herein.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The apparatuses, methods, and systems described herein perform simulating operation of a premises security system from the initiation of a user contacting a customer support agent with a troubleshooting issue, such as an error message, through resolution of the issue. For example, rather than requiring the customer support agent to be granted direct access to the user's account, simulation instead generates a video for the customer support agent, the video capturing the actions the user has performed which led to the error message. This reduces or even eliminates the risk that the customer support agent will be able to make unauthorized changes or perform unauthorized actions to the user's account while in simulation mode. This also improves privacy and security by permanently redacting secure, private, personal, and/or confidential information from the video viewed by the customer support agent, and prevents the customer support agent from un-redacting the protected information.

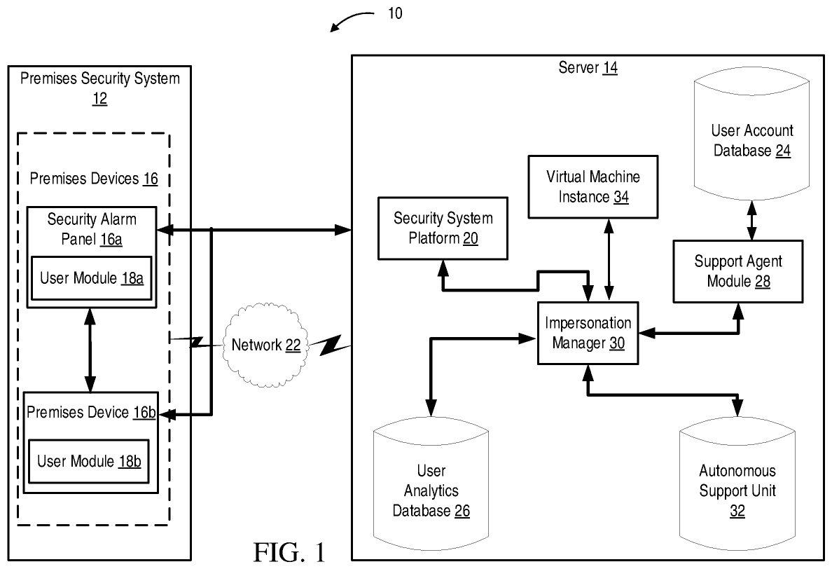

Referring to the drawing figures, in which like elements are referred to by like reference numerals, there is shown in FIG. 1 a diagram of an example system 10 comprising a premises security system 12 and a server 14. Premises security system 12 comprises one or more premises devices 16 such as a security alarm panel 16a and a user module 18a (e.g., implemented in a premises device 16), and may comprise additional premises devices 16 and user modules 18. Although premises security system 12 is shown as comprising a security alarm panel 16a, a premises device 16b, a user module 18a, and a user module 18b, premises security system 12 is not limited to comprising only security alarm panel 16a, a premises device 16b, a user module 18a, and user module 18b and may include additional premises devices 16 and/or user modules 18. Security alarm panel 16a can be in simultaneous communication and/or configured to separately communicate with more than one premises devices 16 and/or user modules 18, such as premises device 16b, user module 18a, user module 18b, in premises security system 12 and/or other premises security system and/or other system 10. Although security alarm panel 16a and premises device 16b are depicted as included in the premises security system 12, security alarm panel 16a and premises device 16b are not limited to being included in the premises security system 12 and/or system 10 and may reside standing alone, as part of another system, or in any other manner. Although user module 18a and user module 18b are depicted as part of the security alarm panel 16a and premises device 16b, respectively, user module 18a and user module 18b are not limited to being part of the premises security system 12, and may be any interface accessible by a user 19 which is co-located with and/or in communication with the premises security system 12 and/or premises devices 16. For example, the user module 18a may be a component of a security alarm panel 16a, such as a touchscreen, and/or may be a physically and/or logically separate component, such as a mobile phone application of a mobile device and/or a web browser portal in communication with the premises security system 12 and/or security alarm panel 16a.

As another example, premises device 16b may be a mobile phone application of a mobile device and/or a web browser portal in communication with the premises security system 12 and/or any component thereof, and/or user module 18b may be a user module of a mobile phone or other device. As used herein, user module 18a and user module 18b may be collectively referred to user module 18.

Further, premises devices 16 may include one or more of sensors, control panels, control devices, image capture devices, life safety devices, lifestyle devices and other devices. For example, the types of sensors may include various life safety related sensors such as motion sensors, fire sensors, carbon monoxide sensors, flooding sensors and contact sensors, among other sensor types that are known in the art. The control devices may include, for example, one or more lifestyle (e.g., home automation) related devices configured to adjust at least one premises setting such as lighting, temperature, energy usage, door lock and power settings, among other settings associated with the premises or devices on the premises. Image capture devices may include digital cameras and/or video cameras, among other image capture devices that are well known in the art, and may also include audio recording functionality using audio recording devices that are well known in the art.

User modules 18 may be implemented by any device (e.g., premises device 16, mobile device, etc.), either standalone or part of premises security system 12 and/or security alarm panel 16a and/or premises device 16b and/or any other premises device, configurable for receiving user inputs and displaying outputs to the user, and further configurable for communicating with any other component/premises device of system 10. User modules 18 may perform one or more functions of a user interface. User modules 18 may correspond to any software/program configured to perform the steps/processes of the present disclosure, e.g., providing an interface for a user to provide an input to the premises security system 12 and/or receive an output from the premises security system 12. Further, user modules 18 may run and/or be included directly as part of any other premises device 16 of premises security system 12. User modules 18 may be virtualized and/or running outside premises security system 12 and/or any of the components of premises security system 12. User modules 18 may be configured to perform a command, such as arming the security system, as directed by the user. User module 18 may be configured to receive an error message and/or other indication of an error, fault, or unexpected result of attempting to perform a command from security system platform 20. User modules 18 may be configured to receive a simulation request from security system platform 20 indicating a request by a server 14 and/or a support agent module 28 for simulation of user modules 18, premises security system 12, and/or security alarm panel 16a and/or premises device 16b and/or any other premises device. User modules 18 may be configured to receive an indication from the user of approval of the simulation request, and may be further configured to send an approval indication to the security system platform 20.

Server 14 may be configurable for direct/indirect communication with premises security system 12 such as one or more of security alarm panel 16a, premises device 16b, user module 18a, user module 18b and/or any other component/premises device 16/user module 18 of system 10. Although server 14 is described as remote from the premises security system 12, server 14 may be co-located with and/or form part of the premises security system 12.

Server 14 functionality may be performed by a single server or distributed among multiple servers or computing devices. For example, server 14 functionality, as described herein, may be performed by an on-site or off-site server. Alternatively, server 14 functionality may be performed by several computing devices that may be located in the same general location or different locations, e.g., cloud computing. In other words, each computing device may perform one or more particular sub-processes of server 14, and may communicate with each other via network 22.

Server 14 may further comprise a user account database 24, security system platform 20, user analytics database 26, support agent module 28, simulation manager 30, and/or autonomous support unit 32, as described below.

Security system platform 20 may be implemented in any device, either standalone or part of server 14, configurable for implementing security monitoring and home automation capabilities. Security system platform 20 may be configured to receive user account data from user account database 24. Security system platform 20 may be configured to receive a request to perform a command from the user module 18a. Security system platform 20 may be configured to return an error message to the user module 18a if the command cannot be performed such as based on the current premises security system 12 configuration. Security system platform 20 may be configured to receive a simulation request from support agent module 28 in order to, for example, assist in diagnostics, troubleshooting, etc. Security system platform 20 may be configured to forward the simulation request to user module 18a and/or user module 18b. Security system platform 20 may be configured to receive simulation approved message from user module 18a and/or user module 18b. Security system platform 20 may be configured to request from the simulation manager 30 a video of the user's actions which led to the error message and/or caused the user's technical support issue to arise. Security system platform 20 may be configured to receive the created video from simulation manager 30. Security system platform 20 may be configured to indicate to support agent module 28 that the video is available.

Support agent module 28 may be implemented by any device, either standalone or part of server 14, configurable for interfacing with a customer support agent. Support agent modules 28 may perform one or more functionality of a support agent user interface. Support agent module 28 may include any software/program configured to perform the steps/processes of the present disclosure, e.g., providing an interface for a user to provide an input to the server 14 and/or receive an output from the server 14. Support agent module 28 may be virtualized and/or running outside server 14 and/or any of the components of server 14. Support agent module 28 may be configured to receive a request from the customer support agent to look up a user account. Support agent module 28 may be configured to receive user account data from user account database 24. Support agent module 28 may be configured to send a simulation request to security system platform 20. Support agent module 28 may be configured to receive a video available message from security system platform 20. Support agent module 28 may be configured to receive a request to play the video from the customer support agent, and is further configured to play the video on the interface, such as on a touchscreen, mobile device, web browser, or similar interface accessible by the customer support agent. Support agent module 28 may be configured to receive a resolve support case indication from the customer support agent, and may further be configured to generate a resolution code, which may be persistent, to store in the autonomous support unit 32.

Simulation manager 30 may be implemented in any device, either standalone or part of server 14, configurable for simulation. Simulation manager 30 may create an annotated video that is displayed to the customer support agent 21, e.g., through a support agent module 28. Simulation manager 30 may be configured to receive a request from the security system platform 20 to create a video of the user's actions which led to the error message and/or caused the user's technical support issue to arise. Simulation manager 30 may be configured to request and receive user actions from the user analytics database 26. The user actions may include actions which led to the error message and/or caused the user's technical support issue to arise. Simulation manager 30 may be configured to receive user account data from user account database 24. Simulation manager 30 may be configured to simulate the user's actions and create a video representing the user's actions. Simulation manager 30 may be configured to instantiate a virtual machine instance 34 based on the premises security system 12 and/or the user actions from the user analytics database 26. Virtual machine instance 34 may be implemented in any device, either standalone or part of server 14, configured to instantiate and/or run a virtual machine instance. Simulation manager 30 may be configured to run the virtual machine instance 34 as a copy of premises security system 12, security alarm panel 16a, premises device 16b, user module 18a, user module 18b, and/or any other component of premises security system 12. Simulation manager 30 may be configured to simulate the user actions defined by the user analytics database 26 in the virtual machine instance 34, for example, to recreate the states of the premises devices 16 and actions which led to the user's troubleshooting/diagnostics issue, and may further be configured to record a video of a virtualized user module of the virtual machine instance 34. Simulation manager 30 may be configured to provide access to the virtual machine instance 34 to the support agent module 28, such that the support agent module 28 may be used to view, modify, and/or run the virtual machine instance 34. Simulation manager 30 may be configured to send the video to the security system platform 20 and/or the support agent module 28.

Autonomous support unit 32 may be implemented in any device, either standalone or part of server 14, configured to be trained, for example, using analytics, the video, and/or resolution codes to build a model for providing user support. Autonomous support unit 32 may be configured to receive, from simulation manager 30, user action information such as a video/images/details representing user actions which led to an error message and/or troubleshooting issue. Autonomous support unit 32 may be configured to receive a set of user analytics representing user actions which led to an error message and/or troubleshooting issue and/or configuration data associated with the premises security system 12 and/or any other component of system 10. Autonomous support unit 32 may be configured to receive user account data from user account database 24. Autonomous support unit 32 may be configured to receive a resolution code from support agent module 28. Autonomous support unit 32 may be configured to train a machine learning model using the resolution code, the user action information (e.g., video), and/or the user analytics. Autonomous support unit 32 may be configured to generate a predicted resolution code based on a set of test data, for instance, a test video and/or test set of user analytics. Autonomous support unit 32 may be configured to improve the prediction accuracy over time as it performs iterative training of the machine learning model using additional data collected over time. Autonomous support unit 32 may be configured to provide technical support, for example, to user module 18a, without the intervention of a customer support agent. Autonomous support unit 32 may be configured to provide information to user module 18a via textual and/or graphic overlays, a chat bot, and/or other automated communication techniques.

Further, system 10 may include network 22, which may be configured to provide direct/indirect communication, e.g., wired and/or wireless communication, between any two or more components of system 10, e.g., premises security system 12, security alarm panel 16a, user module 18a, premises device 16b, user module 18b, server 14, security system platform 20, user account database 24, user analytics database 26, support agent module 28, simulation manager 30, autonomous support unit 32, and/or virtual machine instance 34. In a non-limiting example, security alarm panel 16a of premises security system 12 may communicate with the server 14 via network 22, e.g., to provide troubleshooting data associated with premises security system 12. Although network 22 is shown as an intermediate network between components/devices of system 10, any component/device may communicate directly with any other component/device of system 10. In a non-limiting example, server 14 may communicate directly with security alarm panel 16a and/or user module 18a. For example, network 22 may be an internet protocol (IP) network that may be established as a wide area network (WAN) and/or local area network (LAN), among other IP-based networks.

Note further that functions described herein as being performed by a premises security system 12 or server 14 may be distributed over a plurality of premises security systems 12 and/or servers 14. In other words, it is contemplated that the functions of the autonomous support described herein are not limited to performance by a single physical device and, in fact, can be distributed among several physical devices.

In some embodiments, security alarm panel 16a and user module 18a are co-located in a single hardware device. In other embodiments, the security alarm panel 16a and user module 18a may be located in physically and/or logically separate devices. For example, a user may interface with the security alarm panel 16a via a user module 18a that is implemented in a mobile application, such as an iPhone or Android application, in a web browser accessible on a user's computing device, such as a mobile phone, laptop, or desktop computer, or similar device which is physically and/or logically separate from the security alarm panel 16a.

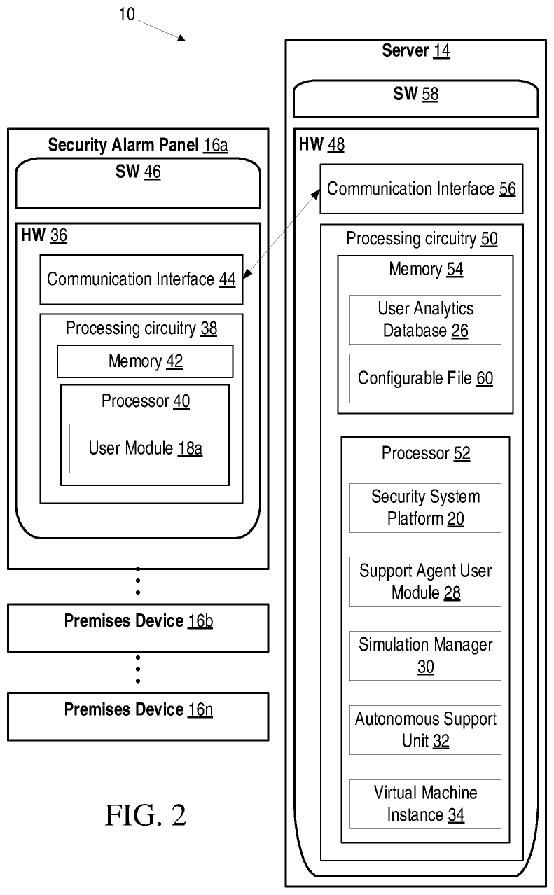

Example implementations, in accordance with an embodiment, of system 10 discussed in the preceding paragraphs will now be described with reference to FIG. 2.

The premises security system 12 includes a security alarm panel 16a including hardware 36. The hardware 36 may include processing circuitry 38. The processing circuitry 38 may include a processor 40 and a memory 42. In particular, in addition to or instead of a processor, such as a central processing unit, and memory, the processing circuitry 38 may comprise integrated circuitry for processing and/or control, e.g., one or more processors and/or processor cores and/or Field Programmable Gate Arrays (FPGAs) and/or Application Specific Integrated Circuits (ASICs) adapted to execute instructions. The processor 40 may be configured to access (e.g., write to and/or read from) the memory 42, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Further, memory 42 may be configured as a storage device.

Hardware 36 of security alarm panel 16a may include communication interface 44 enabling it to communicate directly/indirectly with any component/device of system 10. For example, communication interface 44 may be configured for setting up and maintaining at least a wireless/wired connection with any component/device of system 10 such as server 14. The communication interface 44 may be formed as or may include, for example, one or more wired communication devices, such as USB and/or ethernet devices, and/or may include one or more wireless communication devices, including one or more RF transmitters, one or more RF receivers, and/or one or more RF transceivers.

Security alarm panel 16a further has software 46 stored internally in, for example, memory 42, or stored in external memory (e.g., database, storage array, network storage device, etc.) accessible by the security alarm panel 16a via an external connection.

The processing circuitry 38 may be configured to control any of methods and/or processes described herein and/or to cause such methods, and/or processes to be performed, e.g., by security alarm panel 16a. Processor 40 corresponds to one or more processors 40 for performing security alarm panel 16a functions described herein. The memory 42 is configured to store data and/or files and/or encryption elements, e.g., security tokens/keys, and/or programmatic software code and/or other information described herein. In some embodiments, the software 46 may include instructions that, when executed by the processor 40 and/or processing circuitry 38, causes the processor 40 and/or processing circuitry 38 to perform the processes described herein with respect to security alarm panel 16a. For example, processing circuitry 38 may include user module 18a for performing one or more user module 18a based functions described herein. As another example, user module 18a may be located in physically and/or logically separate devices. For example, a user may interact with the security alarm panel 16a via a user module 18a that is implemented in a mobile application, such as an iPhone or Android application, in a web browser accessible on a user's computing device, such as a mobile phone, laptop, or desktop computer, or similar device which is physically and/or logically separate from the security alarm panel 16a. As another example, security alarm panel 16a may include a user's mobile wireless device, tablet, computer, etc., which includes user module 18a described herein.

In addition to security alarm panel 16a, the premises security system 12 of FIG. 1 may include additional premises devices 16, such as premises device 16b, depicted in FIG. 2, which may include functionally similar hardware and/or software components as another premises device 16, e.g., security alarm panel 16a which is a type of premises device 16. For example, premises device 16b may be a mobile phone or other user module which is configured to communicate with security alarm panel 16a and/or premises security system 12 and/or any other component of system 10. As another example, premises device 16b may be a security alarm panel including hardware similar to security alarm panel 16a. Further, in another example, premises device(s) 16n may include the same hardware and/or software components as another premises device 16 (e.g., security alarm panel 16a which is a type of premises device 16a).

The system 10 further includes server 14 including hardware 48. The hardware 48 may include processing circuitry 50. The processing circuitry 50 may include a processor 52 and a memory 54. In particular, in addition to or instead of a processor, such as a central processing unit, and memory, the processing circuitry 50 may comprise integrated circuitry for processing and/or control, e.g., one or more processors and/or processor cores and/or Field Programmable Gate Arrays (FPGAs) and/or Application Specific Integrated Circuits (ASICs) adapted to execute instructions. The processor 52 may be configured to access (e.g., write to and/or read from) the memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Further, memory 54 may be configured as a storage device.

Hardware 48 of server 14 may include communication interface 56 enabling it to communicate directly or indirectly with any component and/or device of system 10. For example, communication interface 56 may be configured for setting up and maintaining at least a wireless or wired connection with any component or device of system 10 such as premises security system 12. The communication interface 56 may be formed as or may include, one or more wired communication devices, such as USB and/or ethernet devices, and/or may include one or more wireless communication devices, including one or more RF transmitters, one or more RF receivers, and/or one or more RF transceivers.

Server 14 further has software 58 stored internally in, for example, memory 54, or stored in external memory (e.g., database, storage array, network storage device, etc.) accessible by the server 14 via an external connection.

The processing circuitry 50 may be configured to control any of methods and/or processes described herein and/or to cause such methods, and/or processes to be performed, e.g., by server 14. Processor 52 corresponds to one or more processors 52 for performing server 14 functions described herein. The memory 54 is configured to store data and/or files and/or encryption elements, e.g., security tokens/keys, and/or programmatic software code and/or other information described herein. For example, memory 54 and/or processing circuitry 50 and/or processor 52 may include a user analytics database 26 such that when a support request is initiated, the user module 18a transmits actions performed by the user to the user analytics database 26, and/or may further include a configurable file 60 listing user module elements and their corresponding sensitivity levels, for example, identifying which user module elements may contain confidential information requiring redaction. In some embodiments, the software 58 may include instructions that, when executed by the processor 52 and/or processing circuitry 50, causes the processor 52 and/or processing circuitry 50 to perform the processes described herein with respect to server 14. For example, processing circuitry 50 of the server 14 may include security system platform 20, support agent module 28, simulation manager 30, autonomous support unit 32, and at least one virtual machine instance 34, as described herein. In particular, the virtual machine instance 34 may be an instance used to simulate, for example, user module 18a, premises device 16 and/or one or more components/devices associated with the premises security system 12 such that configuration changes made to the virtual machine instance 34 of system 12 do not change the configuration of system 12 at the premises, thereby allowing for troubleshooting, diagnostics, verification, etc. of premises security system 12.

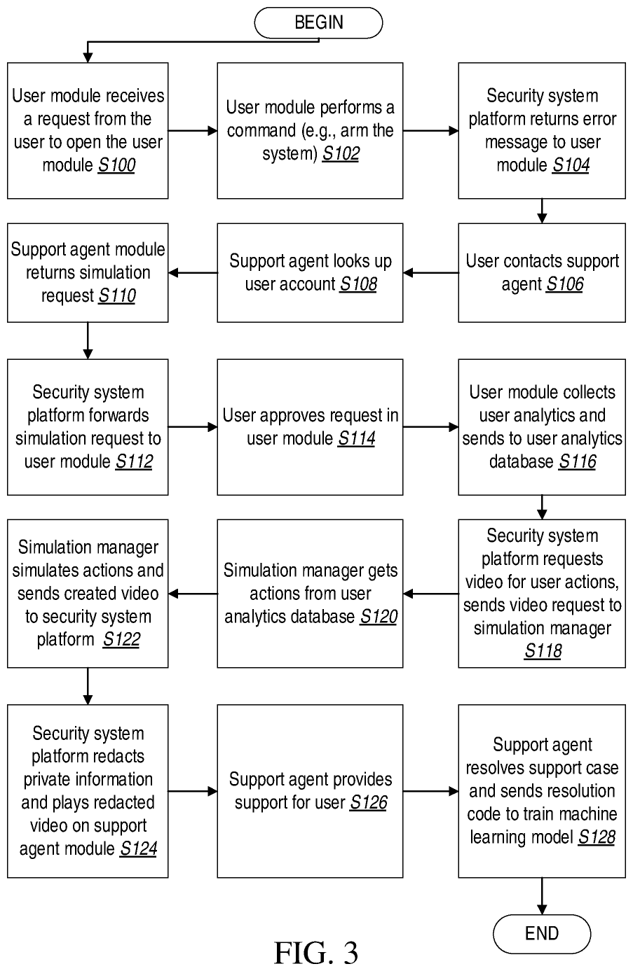

FIG. 3 is a flowchart of an example process in a system 10 for implementing private user simulation for a security system. One or more blocks described herein may be performed by one or more elements of premises security system 12 and/or server 14, such as by one or more of processing circuitry 38 and/or processor 40 and/or communication interface 44 and/or processing circuitry 50 and/or processor 52 and/or communication interface 56. The premises device 16 is configured to receive (Block S100) a request from a user to open a user module 18a. The user module 18a requests the security system platform 20 to perform a command (Block S102), for instance, arming the system. The security system platform 20 returns an error message (Block S104) to the user module 18a, for example, indicating a fault and/or error in attempting to perform the command. Seeking to resolve the error, the user contacts a customer support agent (Block S106), who looks up the user account and/or user profile (Block S108) via the support agent module 28 and generates a support case associated with the user.

The support agent module 28 sends a simulation request to the security system platform 20 (Block S110), which forwards the simulation request to the user module 18a (Block S112). The user approves the simulation request (Block S114) on the user module 18a, and the user module 18a forwards an indication of the simulation approval to security system platform 20. The user module 18a collects user analytics and sends them to the user analytics database 26 (Block S116). Additionally, the user module 18a can provide to the simulation manager 30 information regarding the configuration and operation of the respective premises security system 12. The security system platform 20 requests a video for user actions and sends the video request to the simulation manager 30 (Block S118). The simulation manager 30 gets associated user actions from the user analytics database 26 (Block S120), and simulates those actions, in part, by creating a virtual machine instance, to create a video in which private and/or sensitive information is redacted, which is sent to the security system platform 20 (Block S122). That is, the virtual machine instance is a logical copy of at least one premises device 16 of the customer's premises security system 12 in which the support agent and/or simulation manager 30 and/or security system platform 20 is able to modify aspects of the virtual machine instance without modifying the user's premises security system 12.

The security system platform 20 notifies the support agent module 28 that the video is available, and the customer support agent plays the video (e.g., redacted video to hide sensitive user information) on the support agent module 28 (Block S124). The customer support agent provides support to the user using the redacted video (Block S126), resolves the support case via the support agent module 28 (Block S128), and the support agent module 28 sends a resolution code to the autonomous support unit 32, which trains a machine learning model using the resolution code and the associated user analytics. For example, the support case may be resolved by the support agent using the support agent module 28 to modify one or more configurations of premises security system 12 in the virtual machine instance, thereby allowing the support agent to determine one or more problems with the premises security system 12 configuration at the premises.

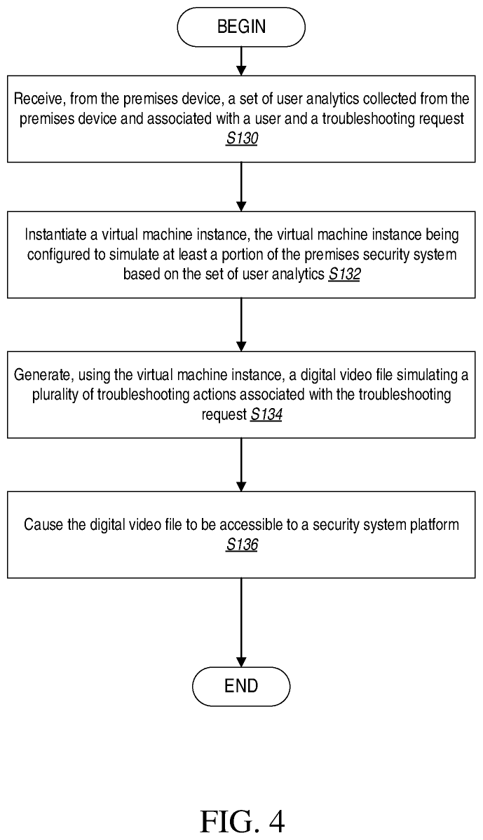

FIG. 4 is a flowchart of an example process in a system 10 for simulation operation of the premises security system. One or more blocks described herein may be performed by one or more elements of premises security system 12 and/or server 14, such as by one or more of processing circuitry 38 and/or processor 40 and/or communication interface 44 and/or processing circuitry 50 and/or processor 52 and/or communication interface 56. The server 14 is configured to receive, from the premises device 16, a set of user analytics, the user analytics being collected from the premises device 16 and being associated with a user and a troubleshooting request (Block S130). The server 14 instantiates a virtual machine instance 34 to simulate operation of the premises device 16 based on the set of user analytics (Block S132). The server 14 generates, using virtual machine instance 34, a digital video file representing the simulated operation of the premises device 16 responsive to a plurality of actions associated with the troubleshooting request (Block S134). The server 14 makes the digital video file available to a security system platform 20 for diagnostic purposes (Block S136).

In an embodiment, a server 14 is configured to communicate at least with a premises device 16. The server 14 is configured to, and/or comprises, a communication interface 56 and/or comprising processing circuitry 50 configured to receive, from the premises device 16, a set of user analytics collected from the premises device 16 and associated with a user and a troubleshooting request, instantiate a virtual machine instance 34 to simulate the premises device 16 based on the set of user analytics, generate using the virtual machine instance 34, a digital video file simulating a plurality of actions associated with the troubleshooting request, and transmit the digital video file to a security system platform 20 for diagnostics.

In an embodiment, the processing circuitry 50 of server 14 is further configured to receive an account lookup request from a support agent module 28, the account lookup request being associated with the user and the troubleshooting request from the user, and retrieve an account profile from a user account database 24 based on the lookup request.

In an embodiment, the processing circuitry 50 of server 14 is further configured to send a simulation request to the premises device 16, and receive, from the premises device 16, in response to the simulation request, a simulation authorization indicating an approval from the user to instantiate the virtual machine instance 34.

In an embodiment, the processing circuitry 50 of server 14 is further configured to redact at least one secure information field in the digital video file to generate a redacted digital video file, and cause the redacted digital video file to play on a support agent module 28.

In an embodiment, the processing circuitry 50 of server 14 is further configured to anonymize the set of user analytics.

In an embodiment, the processing circuitry 50 of server 14 is further configured to receive a case resolution code from the support agent module 28 and train a machine learning model with the autonomous support unit 32 using the set of user analytics and the case resolution code.

In an embodiment, the processing circuitry 50 of server 14 is further configured to receive a second set of user analytics from the premises device 16 and generate a predicted resolution code based on the second set of user analytics and the trained machine learning model.

In an embodiment, the machine learning model includes one of linear regression, logistic regression, decision trees, random forest, and gradient boosting.

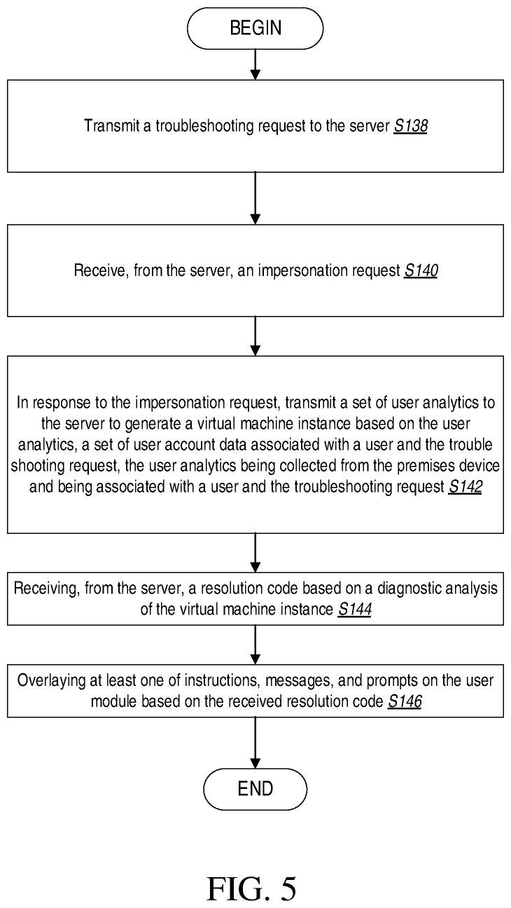

FIG. 5 is a flowchart of another example process in a system 10 for simulating operation of a premises security system. One or more blocks described herein may be performed by one or more elements of premises security system 12 and/or server 14, such as by one or more of processing circuitry 38 and/or processor 40 and/or communication interface 44 and/or processing circuitry 50 and/or processor 52 and/or communication interface 56. The premises device 16 transmits a troubleshooting request to server 14 (Block S138). The premises device 16 receives, from server 14, a simulation request (Block S140). The premises device 16, in response to the simulation request, transmits a set of user analytics to server 14, the user analytics being collected from the premises device 16 and being associated with a user and the troubleshooting request, the server 14 being configured to generate a virtual machine instance 34 based on the user analytics, a set of user account data associated with a user received from user account database 24, and the troubleshooting request (Block S142). The premises device 16 receives, from server 14, a resolution code based on a diagnostic analysis of the virtual machine instance 34 (Block S144). The premises device 16 overlays at least one of instructions, messages, and/or prompts on user module 18a based on the received resolution code (Block S146).

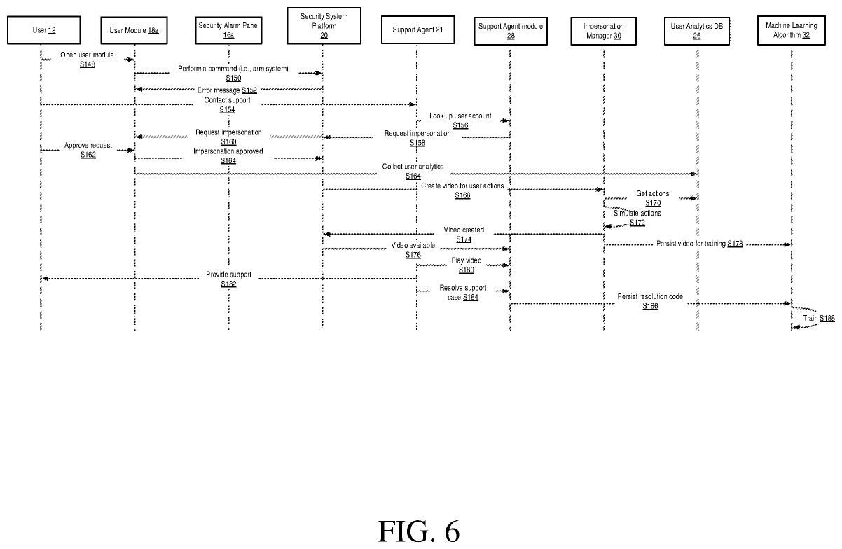

FIG. 6 is a signaling diagram generally corresponding to the steps of FIG. 3. First, a user 19 opens a user module, such as user module 18a (Block S148). The user module 18a sends a request to perform a command, such as to arm the security system, to the security system platform 20 (Block S150). The security system platform 20 returns an error message to the user module 18a (Block S152). The user contacts support, i.e., the support agent (Block S154). The support agent looks up the user's account on the support agent module 28 (Block S156). The support agent module 28 requests simulation via the security system platform 20 (Block S158), which forwards the simulation request to the user module 18a (Block S160). The user approves the request on the user module 18a (Block S162), and the user module 18a sends the simulation approved message to the security system platform 20 (Block S164). The user module 18a sends collected user analytics to the user analytics database 26 (Block S166).

The security system platform sends a request to the simulation manager 30 to create a video for user actions (Block S168). The simulation manager 30 sends a request to the user analytics database 26 to get actions (Block S170), and the simulation manager 30 then simulates actions (Block S172). The simulation manager sends the video created to the security system platform 20 (Block S174), which notifies the support agent module 28 that the video is available (Block S176). The video is sent to the machine learning model for training (Block S178). The support agent plays the video on the support agent module 28 (Block S180), and the support agent provides support to the user (Block S182). The support agent resolves the support case (Block S184) via the support agent module 28, which sends a persist resolution code (Block S186) to the autonomous support unit 32 (Block S188). The autonomous support unit 32, e.g., using a machine learning model, is trained using the code and the user analytics (Block S188).

In an embodiment, the support agent module 28 is configured to retrieve user account information, including a user account profile, e.g., from user account database 24. When a user contacts the customer support agent with a request for troubleshooting, the customer support agent, the support agent module 28 is configurable to create a support case associated with the user's account information and the user's request.

In some embodiments, the user analytics database 26 is configured to receive, store, and/or provide analytics representing the user's actions. The analytics are tagged, for example, by processing circuitry 50, using a unique identifier. The analytics contains information regarding the status and/or configuration of the premises security system 12, the screens and/or pages viewed by the user, the events and/or actions taken by the user, the resulting screens and/or pages, and/or any error messages displayed to the user. The unique identifier is associated with a support case and the user in a temporary table. The temporary table may be stored, for example, in memory 54.

In some embodiments, the simulation manager 30, for example using processing circuitry 50, retrieves some or all user analytics from the user analytics database 26 tagged with the unique identifier. For example, the simulation manager 30, using processing circuitry 64, may place the user analytics in temporal order based on the steps taken by the user.

In some embodiments, the simulation manager 30 creates a new virtual machine instance 34, for example by using processing circuitry 50, processor 52, memory 54, and/or software 58. The virtual machine instance may be associated with and/or be a copy of the user module 18a and/or security alarm panel 16a and/or any other premises device and/or user module of premises security system 12, based on, for example, user analytics, such as the user-agent information retrieved from the user analytics database 26.

In some embodiments, the simulation manager 30 uses the analytics and/or the virtual machine instance 34 to re-play the events and/or actions taken by the user and captures a screenshot of each page. The screenshots may, for example, be stored in memory 54 as digital image and/or digital video files. The re-play may occur at a faster speed than the speed of the user, such as the speed of the hardware 48, at a slower speed than the speed of the user, or at the same speed, as directed by a customer support agent via support agent module 28.

In some embodiments, after each screenshot is captured, the screenshot may be annotated, and the annotated screenshot may be stored in memory 54. For example, the screenshot may be annotated by drawing a bright box around the button pressed by the user, to highlight the textbox in which the user provided input, and/or to highlight other significant and/or relevant portions of the screenshot. Each screen and/or page may, for example, be represented by a separate, annotated image.

In an embodiment, the simulation manager 30 is programmed, for example by a configurable file 60 stored in memory 54, to tag certain fields in the user module 18a as containing secure information, such as personal information, private information, and/or confidential information. The configurable file 60 may, for example, include a list of user module 18a elements and a list of corresponding sensitivity levels.

In an embodiment, the simulation manager 30 simulates the user module 18a by redacting secure information in each simulated user module 18a screen. For example, the simulation manager 30 may overwrite certain pixels of each simulated screen image corresponding to secure information fields. Such overwriting may include, for example, irreversibly blacking out the information or similar redaction which obscures the information contained in the field. This improves the user's privacy and avoids potential privacy violations, for example, since there is no possibility of un-redacting the obscured information in the simulated screen image.

In an embodiment, after the simulation manager 30 simulates the user module 18a, the simulation manager 30 ends the simulated session, and converts the annotated images into a digital video format, for example, a motion jpeg video with a configurable, fixed framerate, such that there are pauses between each screen, which allows the customer support agent to observe the simulated flow of user actions.

In an embodiment, when the customer support agent terminates the support call with the user, the customer support agent enters a resolution code into the support agent module 28. The resolution code may, for example, indicate the premises security system 12 status and/or configuration, the issues which prompted the call, the steps taken to resolve the issue, and/or the status of the issue, such as whether the issue was resolved.

In an embodiment, when the customer support agent terminates the support call with the user, the user analytics unique identifier is permanently deleted. For example, the collected user analytics are anonymized by deleting any association between the collected user analytics and the user.

In some embodiments, the resolution code entered by the customer support agent into the support agent module 28 is associated with the anonymized user analytics, and the resolution code and anonymized user analytics are together provided, by the support agent module 28 and/or the simulation manager 30, to the autonomous support unit 32. The autonomous support unit 32 uses the resolution codes as the labels and the anonymized user analytics as the features for training a machine learning model. For example, the autonomous support unit 32 may utilize a machine learning model including linear regression, logistic regression, decision trees, random forest, gradient boosting, and/or other machine learning models known in the art. The autonomous support unit 32 may employ supervised learning, unsupervised learning, semi-supervised learning, and/or reinforcement learning. The autonomous support unit 32 may be implemented using, for example, a neural network. Once trained, the autonomous support unit 32 may, in response to further user analytic data, generate a predicted resolution code. This prediction code may be provided, for example, to simulation manager 30, support agent module 28, and/or security system platform 20, to improve customer assistance for future calls from the same user and/or other users facing similar technical support issues.

In some embodiments, when provided with sufficiently robust training data and by using a diverse set of training inputs, the autonomous support unit 32 is configured to provide autonomous support, which may be executed, for example, on user module 18a. For example, if the user is presented with an error message, the user may, via user module 18a and autonomous support unit 32, initiate an autonomous support request. The user module 18a generates user analytics associated with the autonomous support request. The autonomous support request, using the autonomous support unit 32, predicts a resolution code based on the user analytics associated with the autonomous support request. The user module 18a uses the predicted resolution code to autonomously provide support instructions to the user without intervention of a customer support agent. In some instances, the user module 18a may use the predicted resolution code to autonomously resolve the technical support issue without requiring any intervention by the user, such as by automatically taking steps defined by the resolution code. In some embodiments, the support instructions are autonomously provided to the user module 18a by overlaying instructions, messages, and/or prompts on the user's screen. In an embodiment, the autonomous support may be provided to the user module 18a via a chat bot. Since the autonomous support unit 32 does not need the involvement of a human, customer support costs can be reduced while providing consistent, high quality support to users. Because the autonomous support unit 32 improves with more training data, it will continue to learn and improve the accuracy of its predictions over time.

In an embodiment, the simulation manager 30 creates one or more virtual machine instance 34 and provides the support agent module 28 with access to the virtual machine instance 34, such that the support agent module 28 may be used to view, modify, and/or run the virtual machine instance 34. For example, the support agent module 28 may be configured to display a virtual user module of the virtual machine instance 34. The support agent module 28 may be used to implement changes in the virtual machine instance 34 via the virtual user module, which may be used, e.g., to perform diagnostics, to reproduce error(s), observe error(s), and/or attempt various corrective actions.

In an embodiment, user module 18a maintains communication with the server 14, e.g., via network 22, such that user module 18a is synchronized with one or more components of server 14. In this embodiment, any changes made to user module 18a may be recorded by the one or more components of server 14 and/or implemented in the virtual machine instance 34 such as to keep the virtual machine instance 34 synchronized with the premises security system 12.

In an embodiment, a premises device 16 including a user module 18 is configured to communicate at least with a server 14. The premises device 16 comprises a communication interface 44 and/or processing circuitry 38 configured to transmit a troubleshooting request to the server 14; receive, from the server 14, a simulation request; in response to the simulation request, transmit a set of user analytics to the server 14 to generate a virtual machine instance 34 based on the user analytics, a set of user account data associated with a user and the troubleshooting request, the user analytics being collected from the premises device 16 and being associated with a user and the troubleshooting request; receive, from the server 14, a resolution code based on a diagnostic analysis of the virtual machine instance 34; and overlay at least one of instructions, messages and prompts on a user module 18 based on the received resolution code.

In some embodiments, the received resolution code is based on a machine learning model maintained by the server 14.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A server configured to communicate with a premises device of a premises security system, the server comprising:
processing circuitry configured to:
receive, from the premises device, a set of user analytics associated with a user, and a troubleshooting request;
instantiate a virtual machine instance, the virtual machine instance being configured to simulate at least a portion of the premises security system based on the set of user analytics; and
generate, using the virtual machine instance, a digital video file simulating a plurality of troubleshooting actions associated with the troubleshooting request; and
cause the digital video file to be accessible to a security system platform.

2. The server of claim 1, wherein the processing circuitry is further configured to:
receive an account lookup request from a support agent module, the account lookup request being associated with the user and the troubleshooting request from the user; and
retrieve an account profile from a user account database based on the lookup request.

3. The server of claim 1, wherein the processing circuitry is further configured to:
cause transmission a simulation request to the premises device; and
receive, from the premises device, in response to the simulation request, a simulation authorization indicating an approval from the user to instantiate the virtual machine instance.

4. The server of claim 1, wherein the processing circuitry is further configured to:
redact at least one secure information field depicted in the digital video file to generate a redacted digital video file; and
cause the redacted digital video file to play on a support agent module.

5. The server of claim 1, wherein the processing circuitry is further configured to anonymize the set of user analytics.

6. The server of claim 1, wherein the processing circuitry is further configured to:
receive a case resolution code from the support agent module; and
train a machine learning model with an autonomous support unit using the set of user analytics and the case resolution code.

7. The server device of claim 6, wherein the processing circuitry is further configured to:
receive a second set of user analytics from the premises device; and
generate a predicted resolution code based on the second set of user analytics and the trained machine learning model.

8. The server of claim 6, wherein the processing circuitry is further configured to instantiate the virtual machine based on a configuration of the premises security system.

9. A method implemented by a server configured to communicate with a premises device of a premises security system, the method comprising:
receiving, from the premises device, a set of user analytics associated with a user, and a troubleshooting request;
instantiating a virtual machine instance, the virtual machine instance being configured to simulated at least a portion of the premises device based on the set of user analytics;
generating, using the virtual machine instance, a digital video file simulating a plurality of actions associated with the troubleshooting request; and
causing the digital video file to be accessible to a security system platform.

10. The method of claim 9, wherein the method further comprises:
receiving an account lookup request from a support agent module, the account lookup request being associated with the user and the troubleshooting request from the user; and
retrieving an account profile from a user account database based on the lookup request.

11. The method of claim 9, wherein the method further comprises:
sending a simulation request to the premises security system; and
receiving, from the premises device, in response to the simulation request, a simulation authorization indicating an approval from the user to instantiate the virtual machine instance.

12. The method of claim 9, wherein the method further comprises:
redacting at least one secure information field depicted in the digital video file to generate a redacted digital video file; and
causing the redacted digital video file to play on a support agent module.

13. The method of claim 9, wherein the method further comprises anonymizing the set of user analytics.

14. The method of claim 9, wherein the method further comprises:
receiving a case resolution code from the support agent module; and
training a machine learning model with the autonomous support unit using the set of user analytics and the case resolution code.

15. The method of claim 14, wherein the method further comprises:
receiving a second set of user analytics from the premises device;
generating a predicted resolution code based on the second set of user analytics and the trained machine learning model.

16. The method of claim 14, further comprising instantiating the virtual machine based on a configuration of the premises security system.

17. A premises device of a premises security system configured to communicate with a server, the premises device comprising:
processing circuitry configured to:
cause transmission of a troubleshooting request to the server;
receive, from the server, a simulation request;
in response to the simulation request, cause transmission of a set of user analytics to the server to cause the server to instantiate a virtual machine instance based on the set of user analytics;
receive, from the server, a resolution code based on a diagnostic analysis from the virtual machine instance; and
cause the overlay of at least one of an instruction, a message, or a prompt on a user module based on the received resolution code.

18. The premises device of claim 17, wherein the received resolution code is based on a machine learning model maintained by the server.

19. The premises device of claim 18, wherein the processing circuitry is further configured to cause transmission of data representing a configuration of the premises security system to the server.

20. The premises device of claim 18, wherein the processing circuitry is further configured to:
cause transmission of a second set of user analytics to the server; and
cause generation of a predicted resolution code based on the second set of user analytics and the trained machine learning model.
